(19) United States
(12) Patent Application Publication
(10) Pub. No.: US 2026/0312417 A1
(43) Pub. Date: Oct. 8, 2026

(54) ELECTRICAL GENERATOR SET WITH REDUCED FOSSIL FUEL CONSUMPTION

(71) Applicant: On-Point Defense Technologies LLC, Fort Walton Beach, FL (US)

(72) Inventor: John Wootton, St. Louis, MO (US)

(21) Appl. No.: 19/635,866

(22) Filed: Apr. 1, 2026

Related U.S. Application Data
(60) Provisional application No. 63/783,028, filed on Apr. 3, 2025.

(51) Int. Cl. H02J 7/50; H02J 7/00; H02J 7/32; H02J 101/40

(52) U.S. Cl. CPC H02J 7/50; H02J 7/32; H02J 7/855; H02J 2101/40; H02J 2207/40

(57) ABSTRACT

A generator which utilizes a hybrid power source comprising an intermittent direct source (e.g. solar or wind) and a steady speed combustion source (e.g. a fuel-burning engine) acting in combination to improve fuel efficiency compared to a variable speed or traditional fixed speed combustion engine generator. Operation of the combustion source is improved by it operating at near-peak or peak efficiency at a fixed speed at most times. This is done by the generator itself creating a load which is, effectively, constant, regardless of the actual load attached using a battery pack which, typically, can be subdivided into charged and discharged portions.

### CROSS REFERENCE TO RELATED APPLICATION(S)

This application claims the benefit of U.S. Provisional Patent Application Ser. No. 63/783,028 filed Apr. 3, 2025, the entire disclosure of which is herein incorporated by reference.

### BACKGROUND OF THE INVENTION

### Field of the Invention

This disclosure relates to electrical generators for production of electricity in locations not connected to an electrical grid and typically remote. Specifically, the generators are designed to provide improved combustion fossil fuel efficiency over existing variable (and constant) speed combustion-based generators.

### Description of the Related Art

Electrically powered devices are ubiquitous in the modern world and it is difficult to do anything without them. Currently, electrically powered devices typically utilize electricity provided as part of a municipal electric grid. The electrical grid utilizes large electrical power plants which generate electricity from a wide range of technologies including combustion, environmental (such as wind, sunlight, water flow, and geothermal activity), and nuclear and feed it to a large distribution network connected to multiple users in a large geographic area. Electricity is generated solely at the plant and then distributed to those attached to the grid as needed. Typically the amount of electricity available to any user is substantially more than they need, and these electrical grids supply homes and businesses everyday with electricity.

Because of the ready availability of electrical grid connections, the average American's life is reliant on the availability of electricity from the grid. Our food storage and preparation, for example, is typically built around the ready availability of grid electricity. Further, environmental control (heating and cooling) is similarly typically reliant on electricity availability. Potentially most important of all, virtually all light sources used by humans when the sun is not available are reliant on electricity (as opposed to fire as they were for thousands of years).

While municipal grids are robust, they are subject to damage due to weather, equipment failure, and purposeful or accidental damage by other humans. When this happens, it tends to be massively disruptive. Anyone who has had to deal with an unexpected power outage quickly realizes how much of their life requires electricity. When the power to a home or business goes down, for example, most people lose the ability to prepare food (and their food storage can fail if sufficient time passes), they often also lack environmental control exposing them to dangers of excessive heat or cold, they lose communication devices in the forms of TVs and radios, and they typically lose artificial light. If the outage is relatively short, this is simply an inconvenience, but if it is longer, it can readily become dangerous or fatal.

To deal with a temporary loss of power, most people have emergency devices that provide a minimum viable alternative to the services typically powered by the municipal grid and which can operate without the connection. Most of these devices rely on disposable chemical batteries as the source of their electricity. They are also typically designed to fulfill specific basic needs. For example, it is common for emergency kits to include battery-powered light sources, communication devices, and the like. These are usually simplified and stripped-down versions of those normally used, but that provides a bare minimum of functionality.

While chemical battery-based devices are effective short term solutions, the types of devices which have typically run off of chemical batteries are quite limited. They are often relatively small, have to have relatively little power draw, and even then, often have very limited operational time. This is typically due to the need to operate off of DC power. Chemical batteries typically generate a direct current (DC) output. While many devices can operate using this, larger devices often require alternating current (AC) power to operate.

To provide for longer-term solutions for electricity where there is no grid availability, systems have typically utilized combustion-based generators which can generate AC power. Basically, a relatively small combustion (fuel-burning) engine is used to generate electricity by using the thermal power generated by combustion to drive an alternator. These systems can typically provide a very robust AC electrical output, so long as there is sufficient fossil fuel available to the engine and are often referred as portable electrical generators or “gensets”.

Further, so long as the combustible fossil fuel is available, gensets can operate relatively indefinitely. These generators can, thus, be used to provide an alternative source of power to a municipal grid, but one which can effectively power the structure (or devices) to which it is attached as if the structure was still connected to the electrical grid. As such it can operate AC devices and re-charge DC devices which have rechargeable batteries. In effect, the generator is the same as a municipal combustion-based power plant, just on a much smaller scale and supplying a single structure or small area as opposed to a large grid.

In the civilian world, generators are most common for emergency use. Buildings will often include a generator to act as backup power should the power from the grid be disrupted. In effect, the generator acts as a small power plant that supplies the electrical needs to the building should municipal power be disrupted. This allows the building operations to continue without disruption and for buildings to maintain critical electrical functions (and even those that are not) in the event of a grid outage. However, generators are not just useful in emergencies. At various sizes they are used to power devices and even settlements which are not connected to an electrical grid at all. This can, for example, enable the construction of buildings in very remote places or the establishment of temporary buildings or settlements.

Based on the above, one may ask why generators, if so good at supplying robust power to a single building, are not always used to supply power to such buildings. The reason usually boils down to cost and consistency. In some cases, generators are used at the individual level such as personal solar systems. However, these systems are usually not based on fuel-burning combustion engines, but on alternative electrical generation technologies such as solar panels or wind turbines. These technologies tend to have fairly flat efficiency across different scales and provide inconsistent or intermittent power due to them being dependent on external uncontrollable factors (such as the weather). As such, they usually need to be supplemented by a combustion technology.

A fuel-burning combustion generator for a single building, however, is typically vastly less efficient than a large fuel-burning powerplant of the same type, which is also often much more efficient than a scaled-up version of many alternative energy technologies. Further, electrical generators require maintenance and the availability of inputs. A wind turbine is only useful for generating electricity when the wind is blowing while a fuel-burning engine produces power consistently so long as there is fuel availability. As electricity use is typically relatively constant, and independent of other variables, smaller generators end up being much more expensive to operate than large power plants, particularly when combustion engines are used.

The value of a fuel-burning engine-based generator, however, is its independence from environmental factors and portability. Such an engine, so long as it has fuel, can typically operate over a wide range of temperatures, in light and dark, and in a variety of weather conditions. It is not reliant on environmental factors to generate electricity and can do so consistently. This benefit is also a hinderance, however, as a fuel-burning engine requires one thing, combustible fossil fuel. While some engines can operate on a wide variety of materials (for example wood burning stoves can operate on virtually any form of combustible), it has long been recognized that energy dense materials (such as petroleum or coal) are best as the engine can be built to operate better (and more efficiently) with these fuels, and, because of their energy density, they are cheaper to transport to the engine for the amount of power they can provide.

One place that smaller gensets are commonly used is the military. Electricity is required by military personnel in areas where a grid is unreliable, enemy controlled, destroyed, or non-existent. In these types of circumstances, while electrical power is not commonly available, combustible fossil fuel is often readily available because it is essential to power fighting vehicles, logistical trains, and a variety of other things that are not currently powered by electricity. Thus, so long as the combustible fossil fuel is available, and a genset is present, the generator can be used to provide electricity to military forces in the field. This, in turn, can enable a greater number of advanced electronics to be used in a greater variety of roles. As warfare necessarily becomes more electrically based, the need for electricity in such locations continues to increase. Fuel on the battlefield is expensive in both financial cost, as it has to be transported to the battlefield, and in human cost in terms of casualties sustained by those carrying out the transportation.

An enemy is aware of the importance of fuel on the battlefield and it is often their intent to thwart the delivery of fossil fuel products necessary in the generation of electrical power. This may be through direct conflict or through area denial type operations where needed transportation is rendered more difficult through the purposeful destruction of transportation infrastructure or the placement of barricades, mines, or improvised explosive devices (IEDs) along travel routes. Alternatively, even a credible threat of the above occurring often forces the fossil fuel delivery to be carried out in a more cautious and slower manner or the use of a safer, but much more expensive, fossil fuel delivery system.

America's recent conflicts in the Middle East, which is a relatively distant location from the direct resources of the United States, proved that the cost of providing combustible fossil fuel in the field can be significant. Because of the prevalence of the internal combustion, diesel, and turbine engines in transportation and fighting vehicles, chemical fuel in the modern world is most commonly some form of refined petroleum. In American military forces since the 1980s there has been a desire to utilize a single type of petroleum-based fuel in all combustion engines to simplify logistics. The fuel used is a kerosene-based fuel known as “Jet Propellant 8” or, more commonly “JP 8.” JP 8 is ideally used as the fuel for all petroleum-based combustion engines in the army.

While this fuel standardization is valuable to simplify logistics, it has a major downside because the standardization results in expense. Because of the need to operate all forms of engines, JP 8 is essentially formulated to meet the requirements of the most demanding applications (typically aircraft engines) and is often not ideal for other applications where that formulation may result in less efficient engine operation making those engines consume greater quantities of fuel than they would under other circumstances. Further, even while universal JP 8 is a target, many systems still use commercial gasoline and diesel (or at least can do so to provide flexibility). As can also be appreciated, in addition to JP 8 being a more expensive, per gallon, fuel to produce, delivery of any type of fuel to the battlefield or any form of remote operation, is also expensive. Logistic trains and fuel depots are common targets of military operations as crippling the flow of necessary supplies to those directly fighting can be an efficient way to defeat them. Further, logistic trains themselves need to use fuel to transport the fuel.

Because of all these problems, the actual cost of using JP 8 in the field is high. The cost of JP 8 at the battlefield is often between $40-$400 per gallon and this does not include any calculation of the associated human life cost in its delivery. Because of these concerns, it is of paramount importance that military engines operate at the maximum possible efficiency. For some engines (such as those in fighting vehicles) tradeoffs have to be made to promote the vehicle's combat effectiveness (which is its primary purpose) so engine efficiency takes into account not just the fuel consumed, but the resultant vehicle performance. For other applications however, increases in efficiency can provide for benefits not just in cost savings, but in freeing up fuel resources for use with direct combat units. One such application where improvement in operational efficiency can be made is in gensets.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein is a generator which utilizes a hybrid power source comprising an intermittent direct source (e.g. solar or wind) and a steady speed combustion source (e.g. a fuel-burning engine) acting in combination to improve fuel efficiency compared to a variable speed or traditional fixed speed combustion engine generator. Operation of the combustion source is improved by it operating at near-peak or peak efficiency at a fixed speed at most times. This is done by the generator itself creating a load which is, effectively, constant, regardless of the actual load attached using a battery pack which, typically, can be subdivided into charged and discharged portions.

There is described herein, in an embodiment, an electrical generator comprising: a combustion engine operating at a single fixed speed, the combustion engine operating at the speed having a selected power generation point when operating at peak efficiency; a battery pack, the battery pack being subdivided into a plurality of battery pack portions; an intermittent power source for charging the battery pack; a system controller; and an alternator; wherein, when a load less than the power generation point is placed on the generator and the combustion engine is operating, the system controller provides a power difference between the selected power generation point and the load from the combustion engine to the battery pack; and wherein, when a load greater than the power generation point is placed on the generator and the combustion engine is operating, the system controller provides a power difference from the selected power generation point to the load from the battery pack to the load.

In an embodiment of the generator, the intermittent power source charges a first portion of the plurality of battery pack portions while a second portion of the plurality of battery pack portions provides the power difference to the load.

In an embodiment of the generator, the intermittent power source comprises a solar panel.

In an embodiment of the generator, the combustion engine runs on a fossil fuel.

In an embodiment of the generator, the fossil fuel comprises JP 8.

In an embodiment of the generator, a first portion of the plurality of battery pack portions which is discharged receives the power difference from the combustion engine.

In an embodiment of the generator, a second portion of the plurality of battery pack portions which is charged does not receive the power difference from the combustion engine.

In an embodiment of the generator, when the combustion engine is not operating, the system controller provides power to the load from the battery pack.

In an embodiment of the generator, when the combustion engine is not operating, the system controller provides power to the load from a first portion of the battery pack, which is charged.

In an embodiment of the generator, when the combustion engine is not operating, the system controller provides power from the intermittent power source to a second portion of the battery pack, which is discharged.

There is also described herein, in an embodiment, a method of generating electrical power using a hybrid electrical generator, the method comprising: providing a hybrid electrical generator comprising: a combustion engine; a battery pack, the battery pack being subdivided into a plurality of battery pack portions; an intermittent power source; and an alternator; only when a first portion of the battery pack is charged, providing power to the load from the first portion; only when a second portion of the battery pack is discharged and the intermittent power source is available, providing power to the second portion from the intermittent power source; only when both the first portion and the second portion of the battery pack are discharged and the intermittent power source is unavailable, operating the combustion engine at a single fixed speed, the speed having a selected power generation point where the combustion engine is operating at peak efficiency; only when a load less than the power generation point is placed on the generator and the combustion engine is operating, providing a power difference between the selected power generation point and the load from the combustion engine to the battery pack; and only when a load greater than the power generation point is placed on the generator and the combustion engine is operating, providing a power difference from the selected power generation point to the load from the battery pack to the load.

In an embodiment of the method, the intermittent power source charges the second portion while the first portion provides the power difference to the load.

In an embodiment of the method, the intermittent power source comprises a solar panel.

In an embodiment of the method, the combustion engine runs on a fossil fuel.

In an embodiment of the method, the fossil fuel comprises JP 8.

In an embodiment of the method, the second portion receives the power difference from the combustion engine.

In an embodiment of the method, the first portion does not receive the power difference from the combustion engine.

In an embodiment of the method, when the intermittent power source is available, the combustion engine is not operating.

In an embodiment of the method, the load is moved from the first portion to the second portion after the second portion is charged.

In an embodiment of the method, only after the load is moved and the intermittent source remains available, the intermittent power source provides power to the first portion of the battery pack.

### BRIEF DESCRIPTION OF THE DRAWINGS

FIG. 1 provides a general block diagram of a first embodiment of a generator. This embodiment utilizes an intermittent renewable energy source in the form of a solar cell in conjunction with a variable speed combustion source.

FIG. 2 provides a general block diagram of a subdividable battery pack with a first group of sub-component batteries connected to the source and a second group connected to the load.

FIG. 3 provides the same battery pack as FIG. 2, but with the first group connected to the load and the second group connected to the source.

FIG. 4 provides a general block diagram of a second embodiment of a generator. This embodiment utilizes an intermittent renewable energy source in the form of a solar cell in conjunction with a constant speed combustion source where both feed the same battery pack.

FIG. 5 shows a general block diagram of how to perform dynamic balancing of the load of a generator such as that of FIG. 4.

FIG. 6 provides a Brake-Specific Fuel Consumption (BSFC) graph for a hypothetical fossil fuel driven engine.

### DETAILED DESCRIPTION OF PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives, and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

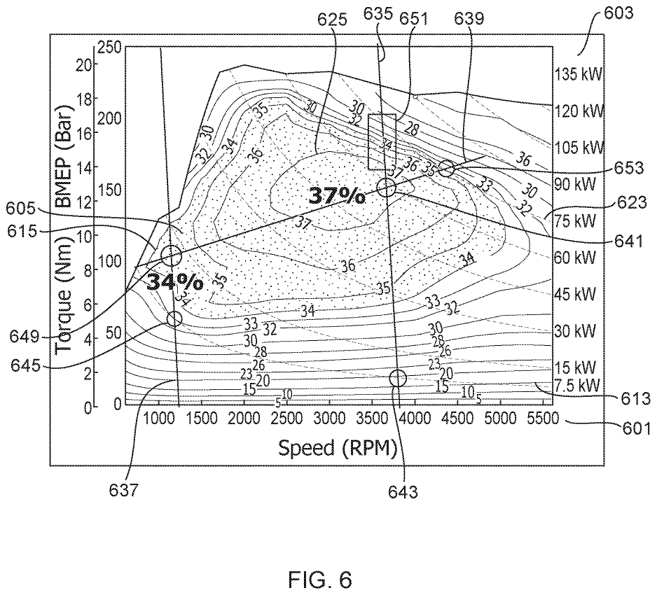

It is well known that combustion engines change their efficiency when operating at different shaft rotation speeds. This is illustrated by a Brake-Specific Fuel Consumption (BSFC) graph such as the hypothetical one included here as FIG. 6. FIG. 6 is provided as simply a hypothetical BSFC graph for a hypothetical engine for illustrative purposes. It should be recognized that each engine has a different BSFC graph and implementation of the principles and teaching of the present application would be specifically chosen for each specific engine and environment it was operating within.

For the purpose of this disclosure, it is important to recognize that the horizontal axis (601) corresponds to the speed (in RPM) of the rotational shaft. The right vertical axis (603) indicates the load value, but the lines for it are not horizontal. Instead, they are the lines that lead from the right axis and curve upward. For example, the line (613) corresponds to the engine producing 7.5 kW of power and the line (623) corresponds to the engine producing 75 kW of power. The various landscape lines correspond to the engine's efficiency at any given speed and with any given load. The shaded area (605) (which is everything inside the line for 34%) is considered efficient operation for this hypothetical engine. The engine's maximum efficiency is obtained by operating inside the line (625) where the engine is 37% efficient.

It is known that combustion engines that run at a constant speed over a broad load range lose thermal efficiency when operating at loads less than full. This is illustrated by the lines (635) and (637). The line (635) shows the efficiency of the engine of FIG. 6 operating at around 3800 RPM. Changing the load attached (which represents the demand on the resultant generator) results in moving up and down that line (635). Thus, if demand is for 60 kW of power (the circle (641)), the engine is 37% efficient. However, if demand is for only 7.5 kW (the circle (643)) the engine is only operating at 20% efficiency. It should be apparent that operating at line (635) makes the engine far more efficient (around 33%) when demand (load) is at 7.5 kW (the circle (645)), but the engine at this slower rotation cannot even produce 60 kW of power so this speed of fixed operation would not provide the ability to meet peak load requirements in this hypothetical arrangement.

A backup emergency generator for a building can be sized to provide output specific to the load of the electrical infrastructure it will be expected to operate. As such, most backup generators are designed to operate at a fixed speed, and that speed (and the selected engine itself) is simply selected based on the necessary load. Thus, a civilian backup generator can operate at a fixed speed (e.g. 3800 RPM) and will typically only operate at circle (641) or close to it simply because minimal change in load will occur over time. Thus, the point (641) can be the universal point of operation because since the load doesn't change, the speed can also not change.

A military generator, however, will typically need to operate over a wide variety of loads depending on the specific requirements of the time and environment. Variability in load can be considered a near given in a military genset (and also occurs in a number of civilian applications) so the fixed speed operation contemplated above does not get paired with a fixed load. Instead, of operating at the point (641), a military genset could be operating at any point on the line (635) within its load parameters. For purposes of this example, this is assumed to be the range 7.5 kW to 75 kW. As can be seen from FIG. 6, operating along the line (635) in this large range is quite inefficient since a good percentage of the line (635) is outside the shaded area (605). Because of this, military gensets, (at least those 3 kW and above) have traditionally operated at variable speed so that the speed may be selected based on the currently present load to provide for increased efficiency in fuel consumption.

Operation at variable speed is performed by allowing the engine to speed up or slow down depending on the load. The specific speed of the engine is selected based on the actual load. This is illustrated in FIG. 6 with the diagonal line (639). In variable speed operation, if demand is for 7.5 kW of power, the engine is slowed to run at 1200 RPM, where that power production is now around 33% efficient (circle (649)). If additional power is demanded (so the load goes up to 60 kW), the RPM is increased to 3800 RPM to produce at circle (641) and 37% efficiency. This variable speed operation places virtually all the variable load parameter inside the shaded portion (605).

The concept of using variable speed to provide efficiency is relatively straightforward and simply requires tracing the optimum engine efficiency curve versus demand power (basically line (639) in FIG. 6). However, it is a multiple variable problem. In most commercial generators the combustion engine operates at a fixed speed. Because of the way the load impacts the alternator operation, the efficiency of the generator will always increase until the maximum load is attached to the generator. If the load is above the maximum, the engine will typically lack the power to drive the alternator as needed to supply the load. If the load is below the maximum, there is “extra” electrical generation which is not being used and is lost. This loss creates the inefficiency.

Basically, for each different speed that a fuel-burning engine can run at, the engine has a different efficiency curve based on load with the point of best efficiency being the maximum load that the motor can supply at that speed. Thus, a variable speed generator is designed to operate at different speeds based on the load present so that the speed selected has a maximum load which is close to the load currently attached.

Unfortunately, since tracing the optimum engine efficiency curve versus demand power results in a variable speed as a function of load, this results in a variable rectified direct current (DC) rail, which in turn leads to a very complex, expensive and heavy inverter in order to maintain a constant frequency and amplitude alternating current (AC) output which is what is typically needed as output from the generator.

The need for the output power to be of constant amplitude and frequency (since that is required by the electrical devices that will use the output) creates a problem because such constant power cannot be directly generated by variable speed operation. Instead, in existing variable speed generators the constant output power is typically achieved through the inclusion of sophisticated, heavy and expensive electronic three-phase inverters. The inverter represents a significant part of cost and weight of the generator and is also often the least reliable part as it is typically susceptible to electronic interference (such as an EMP), and is usually not field repairable.

The present disclosure contemplates modified electrical generators which utilize a hybrid power source comprising an intermittent direct source (e.g. solar or wind) and a steady speed combustion source (e.g. a fuel-burning engine) acting in combination to improve fuel efficiency compared to a variable speed or traditional fixed speed combustion engine generator. Specifically, embodiments of the generators not only gain from the additional power source (the intermittent direct source), but operation of the combustion source is improved by it operating at near-peak or peak efficiency at a fixed speed at most times. This is done by the generator itself creating a load which is, effectively, constant, regardless of the actual load attached. The constant load is created by using an alternator and battery pack to increase a load on the combustion engine when the load is too low. The battery pack is also subdividable into portions so that the battery pack can supply up to a maximum load until it is close to completely drained, even if it is charging simultaneously.

It should be recognized that any augmentation of a combustion generator burning a fossil fuel by any renewable energy source that does not burn a fossil fuel will reduce dependency of the generator on the fossil fuel and improve the generator's efficiency when measured as its electrical output per the fossil fuel input. This is regardless of the renewable technology used and whether the generator is of a variable or constant speed nature. However, the two technologies, when used together, can also be operated in conjunction with a specific generator design that makes the result more efficient than the simple combination would be.

To illustrate the principles of this disclosure, it is helpful to walk through three different embodiments of generators which include different numbers of sub-components. In a first embodiment, the system simply allows for switching between two power sources so that an intermittent direct source is used when it is available, and a combustion source is only used when needed. This system improves fuel-efficiency simply through the inclusion of the intermittent renewable energy source, which does not utilize any fuel, but does provide for electrical input. Therefore, an existing generator is augmented by the additional electrical source.

In a more advanced second embodiment, a storage battery for the intermittent renewable energy source is provided which is segmented into multiple separable cells so that some can operate to recharge while others are supplying electricity. In this way, power from the intermittent renewable energy source is less rarely wasted as power from the intermittent renewable energy source is always either consumed by the load, or is stored, unless the batteries are fully charged.

In a still further third embodiment, the battery is used to store extra power (above load) produced from both the intermittent renewable energy source and the combustion source regardless of which is being used. Further, the combustion source is only used when the intermittent source is not available and the battery is drained. This allows for the combustion source to only operate at a single speed, and effectively around maximum efficiency, regardless of the actual load attached to the generator further increasing efficiency of the combination.

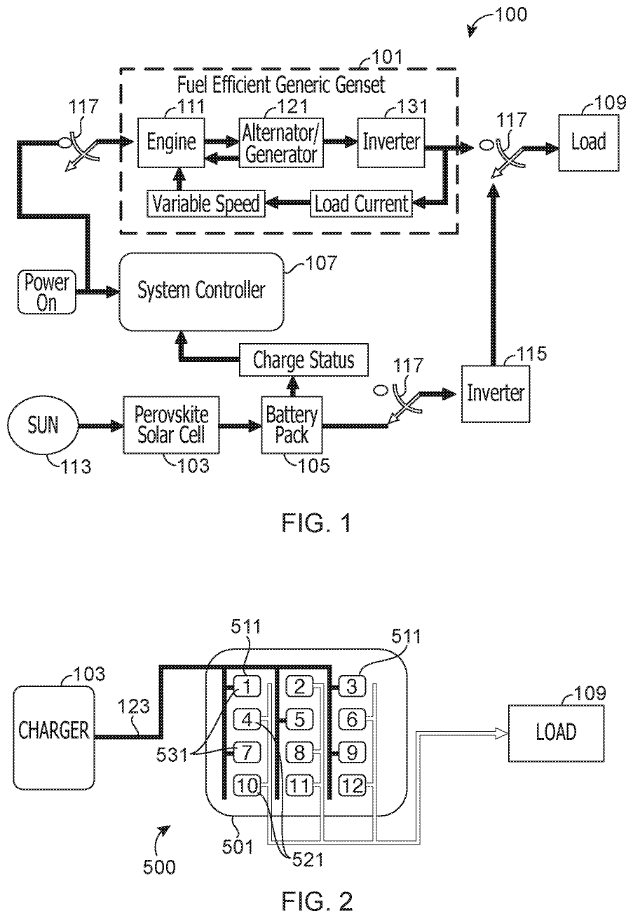

In a first embodiment as shown in FIG. 1, environmental generation (103) is simply added to a combustion-based variable speed generator (101) (or a fixed speed generator in an alternative arrangement). This is achieved with no fundamental change to the existing generator (101) (it maintains the variable speed combustion engine (111) and the associated alternator (121) and invertor (131)) but simply through the inclusion of an intermittent power source (103) such as, but not limited to, a solar cell, a wind turbine, a kinetic generator, or the like. The intermittent power source (101) will typically feed a battery (105) to provide for consistency over the intermittent nature of the intermittent renewable energy source (103).

As shown in FIG. 1, the existing generator (101) operates in accordance with its standard operating methodology when it is operating. When sunlight (113) is available, the solar panel (103) will simply be activated and that will supply to the battery (105). Should a load (109) be attached, the load (109) will draw from the battery (105) via an inverter (115) (to convert to AC) as the solar panel (103) acts to charge the battery (105) in a pass-through operation. As the solar panel (103) is a direct DC generator, and utilizes no combustible fossil fuel, it provides for immediate fuel saving over the existing generator (101).

As indicated, a system controller (107) is provided which allows for switching (117) between the intermittent renewable energy source (103) and the combustion source (101) depending on if the intermittent renewable energy source (103) is available and/or the battery (105) is charged. Basically, if the intermittent renewable energy source (103) has available current and/or the batteries (105) are sufficiently charged to service the load (109), the system controller (107) connects the intermittent renewable energy source (103) (via the battery (105)) to the load (109). If the intermittent renewable energy source (103) is not available and the battery (105) is discharged, the system controller (107) connects the load (109) to the combustion source (101).

By having a battery (105) and intermittent renewable energy source (103), the variable and intermittent nature of the output of the intermittent renewable energy source (103) can be smoothed by the battery (105) in standard pass-through operations. The battery (105) also allows for excess current produced by the intermittent renewable energy source (103) (e.g. when no or a reduced load (109) is attached, but when the sun is shining) to be stored in the battery (105) and used later. If the battery (105) has sufficient charge to operate the load (109), even if the intermittent renewable energy source (103) is not currently producing current, the system controller (107) will typically still connect the load (109) to the battery (105) to use the power in the battery (105) first, before engaging the combustion engine (101) which allows for power generated by the intermittent renewable energy source (103) to always be used first. Since the intermittent renewable energy source (103) does not burn fossil fuel, this is inherently fossil fuel saving.

While the device of FIG. 1 can provide an improvement in fuel efficiency over a basic combustion generator (101) alone, it does so basically only by avoiding use of fossil fuel by simply substituting a different power source since the intermittent renewable energy source (103) does not use fossil fuel. As such, it does not provide for full integration and hybridization of the generator. Particularly, the base embodiment of FIG. 1 is effectively either using one source (battery (105)) or the other (fuel-burning (101)). In many respects, the intermittent renewable energy source (103) is simply a collection device feeding the battery (105) (and providing additional current if the load (109) is above the battery (105) discharge rate) when it is available. When it is not, the combustion engine (101) operates as normal.

While this embodiment provides for improved fuel savings from fuel consumption by the generator (100) as a whole, it actually creates an inefficiency elsewhere. In particular, the addition of the battery (105) and intermittent renewable energy source (103) increases the weight and size of the generator (100) compared to a similar capacity generator (100) with only the variable speed combustion engine (101). As the variable speed generation operation has not changed, the generator (100) is heavier than a system using variable speed combustion (101) alone. Further, pass-through operation of the battery (105) tends to produce additional heat, which can require additional heat shielding and the like which can further increase weight.

In military applications, this means that the generator (100) is more expensive to transport (and also may not be transportable using certain technologies) than the existing variable speed combustion generator (101). A heavier generator takes more fuel to transport to where it is used and this additional fuel use will offset at least some of the gain from the inclusion of the intermittent renewable energy source (103). While this can be minimized with modern solar technologies, such as the use of perovskite solar panels which are more efficient and lighter than older technologies, the efficiency gain from the inclusion of the second system is likely to more than offset the loss from the increased fuel use in transportation. However, as discussed later alternative embodiments which enhance the generator (100), can provide benefits in both areas.

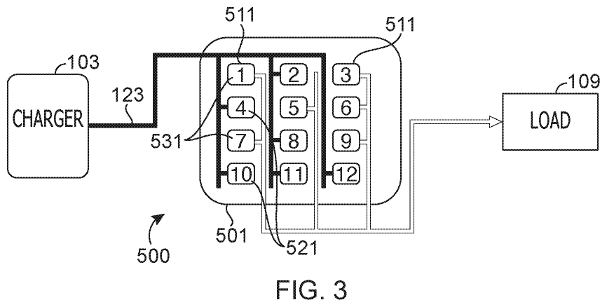

In a second embodiment of the present generator (100), the system of FIG. 1 is modified to utilize a segmented battery system (500) in place of the battery (105). An embodiment of such a configuration is shown in FIGS. 2 and 3. From FIG. 1, the battery (105) is replaced by the segmented battery pack (501) of FIGS. 2 and 3. In the embodiment of FIGS. 2 and 3, the output of the solar charging system (103) utilizes a charging bus (123) that can supply segments (511) of the battery pack (501) with power on an individual basis and allows for discharge of segments (511) not currently being charged to the load (109). It should be recognized that an inverter (115) will typically be included in the output, but is not shown in FIGS. 2 and 3 for simplicity. As can be seen in FIGS. 2 and 3, the system (500) allows for the solar system (103) to supply power to a portion (531) of the battery pack (501) in need of charging while the portion (521), which is charged, acts as the source for the load (109). In effect, the battery pack (501) acts as a series of smaller batteries (511). This eliminates pass-through operation as the sub-component batteries (511) are each either being charged or discharged independently.

In order to provide for this type of arrangement, as can be seen in the transition from FIG. 2 to FIG. 3., the battery pack (501) is segmented and the system controller (107) can act to determine which segments (511) are connected to the solar charging system (103), and which are connected to the load (109) at any time. In a further embodiment, some may also be connected to neither, but they are typically not connected to both. This eliminates any pass-through operation. In FIG. 2, a first group (531) of sub-component batteries (511) is connected to the charger (103) while a second group (521) of sub-component batteries (511) is connected to the load (109). In FIG. 3, the system controller (107) has altered the bus as the first group (531) is connected to the load (109) and the second group (521) is connected to the charger (103).

As indicated, in the embodiment of FIGS. 2 and 3 the intermittent renewable energy source (103) does not supply power directly to the load (109), but acts only to charge the battery (501) and then a different portion of the battery (501) acts as the source for the load (109) eliminating pass-through operation. In this way, both the act of charging and discharging is made more efficient which decreases heat loss. The discharge is based entirely on the load (109), so the correct draw is just what is needed.

As the batteries (511) are essentially full when used, this can increase the total possible output to that of the battery (105), but the output of the intermittent renewable energy source (103) will rarely be higher than this anyway. Meanwhile the intermittent renewable energy source (103) can operate at maximum capacity regardless of intermittency and charge the battery (501) regardless of the end load level. The efficiency only breaks down if the batteries (511) are fully charged while the intermittent renewable energy source (103) is available to provide power and there is no load (109). However, this situation is minimized if the system controller (107) provides preference for the battery (501) as in FIG. 1.

Placing the battery (501) of FIGS. 2 and 3 in place of the battery (105) in the embodiment of FIG. 1, the battery (501) is now acting as a source of current for the load (109). The solar panel (103) is then directly supplying current to the portion of the battery (501) not currently being drawn from when the sun (113) is shining and the solar panel (103) is producing a current output. When the solar panel (103) is not producing a current output, the load (109) will typically draw from the battery (501) until the batteries (511) are all depleted (or close to it). At that time, the system controller (107) will switch over to the combustion source (101) from the solar panel (103). As the pass-through operation has been completely eliminated, heat loss (and associated weight from heat shielding) is eliminated further increasing efficiency.

While the operation of the embodiment of FIG. 1 with the battery (501) of FIGS. 2 and 3 provides improved efficiency from the embodiment of FIG. 1 utilizing pass-through operation on battery (105), the resulting generator (100) is still heavier than the original variable speed generator as that same variable speed generator is still present and has additionally the battery (501) and the intermittent renewable energy source (103) included.

In a still further embodiment, a fully integrated system is provided which utilizes the segmented battery (501) of FIGS. 2 and 3 to eliminate the variable speed operation of the combustion engine (101) while still allowing the combustion engine (101) to operate at similar and typically higher efficiency to the variable speed system, and regardless of resultant load. This third embodiment serves to provide a system that reduces fossil fuel use through both alternative technology use and improved efficiency of the engine operation.

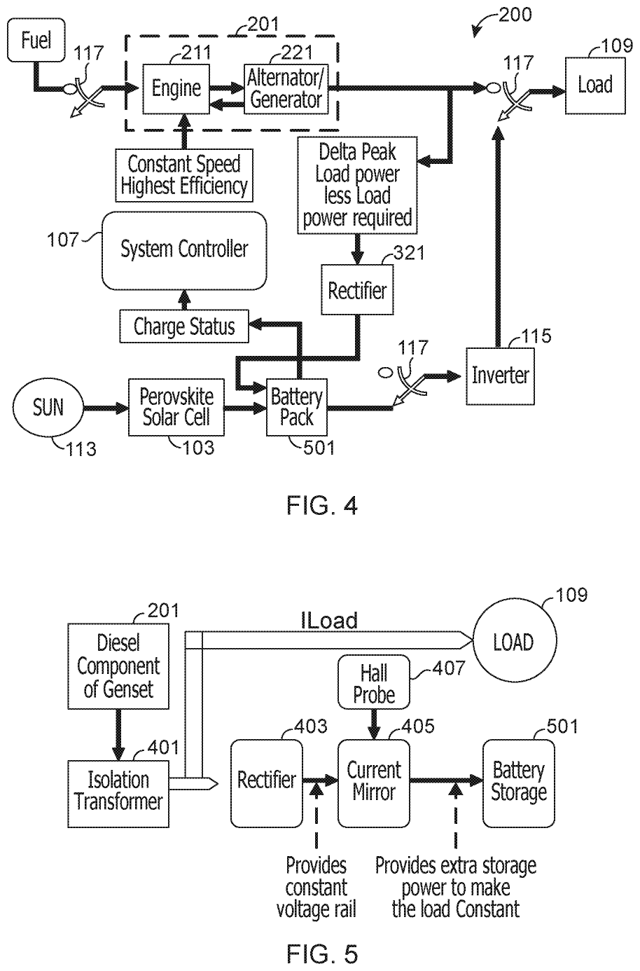

A configuration of a fully integrated generator system (200) is shown in the block diagram of FIG. 4. In typical operation, when the intermittent renewable energy source (103) is solar (as indicted in the FIGS) it is typically only in use for around four hours a day (and is effectively useless at night), however the battery pack (501) is available all day and night. In the embodiment of FIG. 4, the battery pack (501) is utilized as available storage by both the intermittent renewable energy source (103) and the combustion source (201). Thus, it can be used to store the difference between power demanded by the load (109), and the power available from the generator (200) regardless of operational mode.

By having the battery pack (501) act as part of the load for the combustion source (201), the total load (e.g. the actual load (109) plus the load produced from the alternator (221) charging the battery pack (501)) seen by the combustion engine (201) is effectively constant. By being able to make this a constant, the combustion engine (201) can be both set to a constant speed, removing the need for a complex inverter (131), and can allow for the combustion engine (201) to operate in accordance with the most efficient load point of the engine.

Returning to FIG. 6, in this third embodiment, the combustion engine (201) is designed to operate a fixed speed and, therefore, would operate along line (635). However, the engine in actual operation operates at point (641) the vast majority of the time because the load is made fixed. Specifically, the battery pack (501) is used to constrain the load so it cannot drop below the 60 kW load of circle (641). Thus, the engine never operates along the portion of line (635) below point (641). The battery pack (501) and/or intermittent renewable energy source (103) are used to provide power for a load which is above 60 kW when the intermittent renewable energy source (103) is available and when the battery pack (501) has charge. The combustion engine (201) only operates on the portion of the line (635) above the point (641) (which is indicated by the box (651)) in the specific circumstance of the battery pack (501) being completely discharged and the intermittent renewable energy source (103) not being available.

To put it simply, if the actual load is below 60 kW and the combustion engine (201) is operating, excess power produced by the combustion engine (201) is dumped into the battery pack (501) so it is not wasted. If the load is above 60 kW and the combustion engine (201) is operating, the battery pack (501) is drawn from to supplement the combustion engine (201) output. The inclusion of an intermittent renewable energy source (103) in the generator will act to preserve the battery pack (501) charge when it is available (and charge the battery pack (501) if the load is sufficiently low) and essentially reduce the amount of time that the combustion engine (201) needs to operate at all. If the intermittent power source (103) and the combustion engine (201) are both operating, it is either due to a large load either could handle individually. In this circumstance, the combination may generate extra power and that is fed to the battery pack (501). It should be recognized that in an embodiment the combustion engine will not be used to charge the battery pack (501) when no load is attached unless the battery pack (501) has dropped to a level of charge sufficiently low that the battery pack (501) cannot help supplement the combustion engine (201) in any reasonable way and may not be used to charge the battery pack (501) at all.

Thus, the combustion engine (201) will effectively always operate at circle (641) even as the load varies so long as both the battery pack (501) is not fully discharged and the intermittent renewable energy source (103) is unavailable. In this situation (the battery pack (501) is discharged and the intermittent renewable source is unavailable) the load will increase on the combustion engine (201) which drives its efficiency into the box (651). As this situation is relatively rare, and the box (651) is still more efficient than operation at a fixed speed and low load (e.g. circle (643)), the generator gains substantial efficiency and eliminates heavy components such as the three-phase inverter.

It should be apparent from FIG. 6 that the actual efficiency of the generator as a whole is dependent on use. In the absolute worst use case (a 75 kW load all the time with the batteries dead) this embodiment is still 28% efficient which is worse than a variable speed generator (which would be operating at point (653)), but likely similar or better than a traditional fixed speed generator (which would be operating at the exact same point if the fixed speed is the same). However, in any other situation, this embodiment is typically no worse than, and usually better than, either of the existing two options. Further, the system efficiency can be further increased by selecting a different combustion engine or different maximum load. For example, in FIG. 6, if the maximum allowed load is 60 kW, operation in the box (651) is eliminated and the combustion engine (201) always operates at point (641).

An embodiment of an arrangement of this type of generator is shown in FIG. 4. In this arrangement, both the combustion source (201) and the intermittent renewable energy source (103) feed to the battery pack (501). However, the final load (109) may be connected either to the battery pack (501), or to the combustion source (201). Should the battery pack (501) be sufficiently charged to handle the load (109), the load (109) will be connected to the battery pack (501) and run from there. It will typically do so regardless of the availability of the intermittent renewable energy source (103) as the sub-divided battery pack (501) will be present so that the intermittent renewable energy source (103) will either be independently charging the discharged portion of the battery pack (as in FIG. 2 or 3, for example), or not operating. The combustion engine (201) will not be operating when the load (109) is connected to the battery pack (501) which can supply the full load (or when there is no load (109)).

Should the battery pack (501) charge be insufficient to handle the load (109), the system controller (107) will typically first determine if a different subcomponent of the battery pack (501) is available for use and has sufficient charge (e.g. because it had been charging while the remaining sub-components were being used). If this is the case, the system controller (107) may switch over to that alternative portion. If the entire battery pack (501) is sufficiently discharged, the system controller (107) will activate the switches (117) and transition the load (109) to the combustion source (201) which is also connected to the alternator (221) and battery pack (501).

Now the combustion generator (201) will operate at its predetermined speed. If the load (109) corresponds to the maximum (e.g. efficient) load of the combustion generator (201), the combustion source (201) will simply supply the load (109). If the load (109) is less, the combustion source (201) will send any excess to power to the alternator (221) increasing the total load seen by the engine (211). Note that since the alternator (221) is attached to the battery pack (501) (and a portion of it that can be charged because the combustion engine (201) only activated because the battery pack (501) was not fully charged), regardless of the amount of current transferred to the alternator (221), the alternator (221) will transfer that to the battery pack (501). If the actual load (109) is smaller, then the alternator (221) will be more of the total load and the battery pack (501) will charge faster. If the actual load (109) is larger (but still below the predetermined operational level of the combustion engine (201)), the alternator (221) will be less of the total load and the battery pack (501) will simply charge slower. The motor (201) may, thus, operate at a constant speed and the motor (201) and speed may be selected to provide for the desired max output of the specific generator (200) to be at the or near the point of maximum efficiency of that engine (201).

The only inverter (115) is needed when the battery pack (501) is providing the power to load (109). Whether the inverter (115) is a single phase or a three-phase inverter, the design is much simpler (as the DC rail is constant) compared to needing to have a complex inverter (131) feeding the load (109) from the combustion engine (111) driving alternator (121) at variable speed as shown in FIG. 1. By making the inverter (115) a three-phase inverter and by back driving the alternator (221) by the inverter (115), the alternator (221) also becomes the starter of the engine (211). Load-balancing between providing power to the load (109) and power to be stored (for later use) in the battery pack (501) may be achieved schematically via an embodiment such as shown in FIG. 5.

As shown in FIG. 5, the output of the combustion source (201) of the generator (200) not only provides the load power (109), but via an isolation transformer (401), the output voltage is rectified (403) and establishes a constant DC rail for the current mirror (405). A Hall probe or a small series resistor (407) measures the load current. If the load current is less than the optimal desired load current, then the current in the current mirror (405) is increased until the Hall probe (407) registers the desired optimal load current. Conversely should the load (109) demand increase, the Hall probe (407) would register a higher demand then the optimal and would reduce the current in the current mirror (405) until the load current returns to its optimum.

As explained previously when a charge monitor of the battery storage unit (501) assesses that it is charged sufficiently to sustain the current or target load (109) for a significant time, the combustion source (201) may be switched off and the load (109) is maintained by the battery pack (501) until there is only a prespecified minimum (e.g. 10%) capacity left in the battery pack (501). The combustion source (201) is then restarted (if the intermittent renewable energy source (103) remains unavailable) and the cycle resumes.

As should be apparent, the integrated system (200) of FIGS. 4 and 5 allows for the generator (200) to always run at maximum (optimal efficiency) load current and constant speed at all times. No residual from the combustion engine (201) is lost even when the load (109) demand is less than maximum as it is fed to the battery pack (501) (and the combustion engine (201) ceases operation if the battery (501) is full (actually when the battery (501) is considered sufficiently charged to run the load for a reasonable period of time—even if that is not a full charge) even if there is a load attached as the battery (501) supplies the load in that case). Further, the integrated system (200) reduces the total weight of the system (100) by elimination of the invertor (131) of FIG. 1. Thus, the system (200) of FIG. 4 will operate at worst at the same efficiency as that of FIG. 1, but is substantially lighter. However, it will typically also operate at improved efficiency over that of FIG. 1 since the motor (211) may be sized (and the constant operating speed selected) to specifically correspond to the maximum output desired by the generator (200).

It should be recognized that although variable speed was a key to mapping the most efficient part of the engine for a given load, the baseline engine dictates the overall efficiency of the system. The choice of engine for many years in a 3 KW genset produces a 3 kW output at 2,000 RPM crankshaft speed at a consumption of 270 g of diesel per kilowatt hour. At 3 kW output that is 810 g of diesel or 0.25 gallons per hour. It's most efficient point is around the crankshaft speed of 2750 rpm, where it produces 4 kilowatts at a fuel consumption of 240 g of diesel per kilowatt hour, or 960 g of diesel consumes per hour or 0.3 gallons per hour.

Using as a base of 22 hours a day operation, at 3 kW, the engine with a full load would consume 5.52 gallons of diesel per day. Assuming 90% efficiency of the PMG and the inverter combined, and using JP 8 as the fuel, would result in the consumption of 6.828 gallons per day of JP 8.

Today there are diesel engines that are achieving 155 g per kilowatt hour. With the more advanced embodiments contemplated herein, it is possible to find a new engine that will meet all requirements but would also achieve a consumption figure of 200 g per kilowatt hour. The result would be the consumption of 5.06 gallons of JP 8 per day, or a saving of 1.7 gallons of JP 8 per day, or 51 gallons of JP 8 per month.

Assuming the lowest financial values for fuel cost contemplated above, the savings of 51 gallons of fuel a month would result in a cost savings of at least $2040/month which can readily pay for the new generator (200) hardware. Further, while the numbers above are for the 3 kW genset, such cost savings can also be obtained for the whole range of gensets.

Finally, it should be recognized that the frame of the existing military gensets is all metal. Replacement of metal frames with composites and/or other materials can result in still lighter yet stronger generators building on the gains of FIG. 4. The combination of saving weight by constructing the frame of the composites, and the removal of the complex inverter (131), will typically at least offset the additional weight of the battery pack (501) and intermittent renewable energy source (103).

The qualifier “generally,” and similar qualifiers as used in the present case, would be understood by one of ordinary skill in the art to accommodate recognizable attempts to conform a device to the qualified term, which may nevertheless fall short of doing so. This is because terms such as “perpendicular” are purely geometric constructs and no real-world component or relationship is truly “perpendicular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. An electrical generator comprising:
a combustion engine operating at a single fixed speed, said combustion engine operating at said speed having a selected power generation point when operating at peak efficiency;
a battery pack, the battery pack being subdivided into a plurality of battery pack portions;
an intermittent power source for charging said battery pack;
a system controller; and
an alternator;
wherein, when a load less than said power generation point is placed on said generator and said combustion engine is operating, said system controller provides a power difference between said selected power generation point and said load from said combustion engine to said battery pack; and
wherein, when a load greater than said power generation point is placed on said generator and said combustion engine is operating, said system controller provides a power difference from said selected power generation point to said load from said battery pack to said load.

2. The generator of claim 1, wherein said intermittent power source charges a first portion of said plurality of battery pack portions while a second portion of said plurality of battery pack portions provides said power difference to said load.

3. The generator of claim 1, wherein said intermittent power source comprises a solar panel.

4. The generator of claim 1, wherein said combustion engine runs on a fossil fuel.

5. The generator of claim 4, wherein said fossil fuel comprises JP 8.

6. The generator of claim 1, wherein a first portion of said plurality of battery pack portions which is discharged receives said power difference from said combustion engine.

7. The generator of claim 6, wherein a second portion of said plurality of battery pack portions which is charged does not receive said power difference from said combustion engine.

8. The generator of claim 1, wherein, when said combustion engine is not operating, said system controller provides power to said load from said battery pack.

9. The generator of claim 8, wherein, when said combustion engine is not operating, said system controller provides power to said load from a first portion of said battery pack, which is charged.

10. The generator of claim 9, wherein, when said combustion engine is not operating, said system controller provides power from said intermittent power source to a second portion of said battery pack, which is discharged.

11. A method of generating electrical power using a hybrid electrical generator, the method comprising:
providing a hybrid electrical generator comprising:
a combustion engine;
a battery pack, the battery pack being subdivided into a plurality of battery pack portions;
an intermittent power source; and
an alternator;
only when a first portion of said battery pack is charged, providing power to said load from said first portion;
only when a second portion of said battery pack is discharged and said intermittent power source is available, providing power to said second portion from said intermittent power source;
only when both said first portion and said second portion of said battery pack are discharged and said intermittent power source is unavailable, operating said combustion engine at a single fixed speed, said speed having a selected power generation point where said combustion engine is operating at peak efficiency;
only when a load less than said power generation point is placed on said generator and said combustion engine is operating, providing a power difference between said selected power generation point and said load from said combustion engine to said battery pack; and
only when a load greater than said power generation point is placed on said generator and said combustion engine is operating, providing a power difference from said selected power generation point to said load from said battery pack to said load.

12. The method of claim 11, wherein said intermittent power source charges said second portion while said first portion provides said power difference to said load.

13. The method of claim 11, wherein said intermittent power source comprises a solar panel.

14. The method of claim 11, wherein said combustion engine runs on a fossil fuel.

15. The method of claim 14, wherein said fossil fuel comprises JP 8.

16. The method of claim 11, wherein said second portion receives said power difference from said combustion engine.

17. The method of claim 16, wherein said first portion does not receive said power difference from said combustion engine.

18. The method of claim 11, wherein, when said intermittent power source is available, said combustion engine is not operating.

19. The method of claim 18, wherein, said load is moved from said first portion to said second portion after said second portion is charged.

20. The method of claim 19, wherein, only after said load is moved and said intermittent source remains available, said intermittent power source provides power to said first portion of said battery pack.
